(19) United States
(12) Patent Application Publication
(10) Pub. No.: US 2008/0289242 A1
(43) Pub. Date: Nov. 27, 2008

(54) COMPUTERIZED FISHING APPARATUS AND METHOD OF USING SAME

(76) Inventor: Dimitrios G. Cecil, Birmingham, MI (US)

Correspondence Address: BUTZEL LONG;IP DOCKETING DEPT, 350 SOUTH MAIN STREET, SUITE 300, ANN ARBOR, MI, 48104, US

(21) Appl. No.: 12/127,716

(22) Filed: May 27, 2008

Related U.S. Application Data
(60) Provisional application No. 60/940,193, filed on May 25, 2007.

(51) Int. Cl. A01K 87/00

(52) U.S. Cl. 43/18.1 R

(57) ABSTRACT

A fishing rod and lure system for collecting and analyzing fishing data to provide for manual or automatically controlled fishing experience comprising a fishing rod having a handle portion and a shaft portion, a fishing line reel encasing fishing line, a plurality of guides located along the fishing rod for guiding the fishing line, a lure attached to the fishing line, a central control device electrically coupled with the fishing rod for receiving, manipulating and outputting data and configured to control the lure, a display device electrically coupled with the central data device and capable of receiving and displaying data, and a sensor electrically coupled with the central control device for sensing and sending data to the central control device, wherein the central control device uses the data received from the sensor to display data to the user via the display and control the fishing rod and lure system.

### RELATED APPLICATIONS

This application claims the benefit of, and priority to, U.S. Provisional Patent Application No. 60/940,193, filed May 25, 2007, which is incorporated by reference herein.

### BACKGROUND OF THE INVENTION

The present invention relates generally to fishing gear and, more particularly, to a computer integrated fishing rod, reel, line and lure and a method of using the invention and interpreting data collected by the invention to obtain better results in terms of catching fish.

The traditional fishing rod or fishing pole has been around for many years. What started as a simple stick with a string attached and a hook with a worm on the end of the string to entice fish has undergone much advancement over the years. Advancements have been made to the pole, the “string,” and the type of lure used. These advancements are not only with regard to the materials used but also to the functionality of the devices. There are lures that move underwater to attract fish and even scented lures to further entice fish, but most of these lures are designed for certain species of fish and unfortunately, fishers are often using the wrong lure for the type of fish in the water. Oftentimes a fisher does not know what type of lure to use, what type of fish is in the water, if his lure is at the proper depth, or if there are even any fish near his lure. This leaves a lot of guessing to be done by the fisher.

Therefore, there is a need in the art for a fishing apparatus and method for providing data and insight to a fisher in order to increase success rates and to enable a fisher to “see” down in the water.

### SUMMARY OF THE INVENTION

The present invention concerns a computerized fishing rod and lure system for collecting and analyzing fishing data to provide for manual or automatically controlled optimal fishing experience. The system includes a fishing rod having a handle portion and a shaft portion; a fishing line reel; a fishing line encased in the fishing line reel; a plurality of guides located along the fishing rod for guiding the fishing line along the fishing rod; a lure attached to the fishing line; a central control device electrically coupled with the fishing rod for receiving, manipulating and outputting data, the central control device further configured to control the lure; a display device electrically coupled with the central data device and capable of receiving and displaying data from the central control device; and a sensor located on at least one of the fishing rod and the lure and electrically coupled with the central control device for sensing and sending data to the central control device, wherein the central control device uses the data received from the sensor to display data to the user via the display device and control the operation of the fishing rod and lure system. The sensor can provide real time information to the fisher such as line length, lure depth, depth of water, fish strike detection, line tension, rod stress, water temperature, and fish location. This data can be used by a computer program during the fishing process to attract certain species of fish and further enhance the fishing experience.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a perspective view of the preferred embodiment of the present invention;

FIG. 2 is a cross section of the handle portion of the preferred embodiment of the present invention taking along line 2-2 in FIG. 1;

FIG. 3 is a perspective view of a lure in accordance with the preferred embodiment of the present invention; and

FIG. 4 is a schematic diagram of the communication system of the preferred embodiment of the present invention.

### DESCRIPTION OF THE PREFERRED EMBODIMENT

The present invention concerns a fishing apparatus and a system for the collecting and use of data obtained by the fishing apparatus to achieve optimal fishing results. More specifically, the present invention is a computerized fishing apparatus including a rod, reel, line and lure for providing real time information to the fisher such as line length, lure depth, depth of water, fish strike detection, line tension, rod stress, and fish location. This data can be used during the fishing process to attract certain species of fish and further enhance the fishing experience.

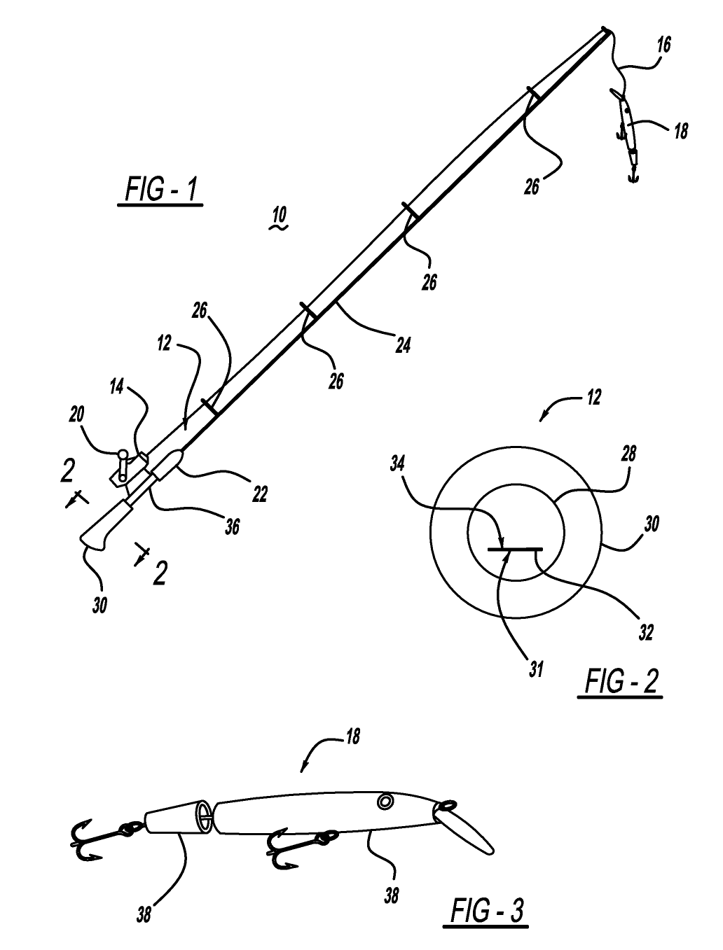

Referring to FIG. 1, the preferred embodiment of the invention is shown generally at 10. The invention is comprised of a rod 12, a reel 14, a line 16, lure 18, and display 20. The rod 12 is preferably made up of a handle portion 22 and a shaft portion 24. In accordance with the preferred embodiment, the reel 14 and display 20 are mounted on the handle portion 22 of the rod 12. The shaft portion 24 further includes a plurality of guides 26 extending therefrom. The line 16 is encased in the reel 14 and extends from the reel 14, through the guides 26 along the shaft portion 24 of the rod 12 where the line 16 is then connected to the lure 18.

Referring now to FIG. 2, the handle portion 22 of the rod 12 of the preferred embodiment is preferably comprised of an inner body 28 and an outer body 30 encasing the inner body 28. The inner body 28 houses a central control device 31. The central control device 31 includes a circuit board 32, a computer chip 34 seated on the circuit board 32, a battery 36 and the necessary wiring. As will be described in more detail hereinbelow, the circuit board 32 and computer chip 34 receive data from other components of the invention and outputs data to the display 20. Preferably, the computer chip 34 is a microcontroller such as Texas Instruments Model MSC1212Y5, but one skilled in the art will appreciate that any similar chip could be used. The battery 36 is used to power the central control device 31 and is preferably rechargeable. In the preferred embodiment of the present invention, the computer chip 34 accepts both digital and analog inputs for real time data acquisition and functions as a 16 Bit A/D and D/A data acquisition device. The computer chip 34 performs the calculations and computations necessary for the present invention and the instructions for performing the calculations and computations resides on the chip 34. Again, this is one way of carrying out the instant invention and one skilled in the art will realize that many modifications to the above description are possible without straying from the scope and spirit of the present invention. For example, multiple chips and/or controllers could be utilized to achieve the same functionality of the one chip 34 as disclosed in the preferred embodiment without straying from the scope of the present disclosure.

Further, while the display 20 is preferably mounted on the reel 14, it is anticipated that the display could be mounted on the handle portion 22 without straying from the scope of the present invention. The display 20 receives data from the central control device 31 and displays the information to the fisher. In turn, the fisher is able to view and control the real time fishing data as well as command and control the invention in view of the data. The command and control of the invention could be manual or computerized via interaction with the computerized elements of the invention. For example, the preferred embodiment of the invention includes a control interface 38 which is preferably located on the display 20. The fisher is able to control and input information into the invention via the control interface 38. The display 20 may also be capable of displaying or signaling audible alarms in certain situations.

Further, with respect to the handle portion 22 of the rod 12, the handle portion 22 preferably contains a functional direction sensor 40 that measures the directional location of the handle in real time and outputs the directional data to the central control device 31. The reel 14 performs typical reeling functions and may also include a length sensor 42 to measure the length of the line 16 and communicate the length data to the central control device 31. The reel 14 has a button 44 for zeroing the data prior to each new casting sequence. While the button 44 is shown on the reel 14, it is anticipated that the button could be located in a variety of places such as on the handle portion 22 or on the display 20 without straying from the scope of the present invention.

Focusing now on the shaft portion 24 of the rod 12, each of the guides 26 located along the shaft portion 24 contains a guide sensor 46 for determining the stress and force of the rod 12 at each guide 26 in real time. Preferably, the guide sensor 46 is a strain gauge sensor but other types of sensors may be used. The guide sensor 46 outputs data to the central control device 31 to be used for calculations performed by the invention. The line 16 used for the present invention is preferably is thin shielded cable such as fiber optic cable, capable of transmitting analog and digital signals from the lure 18 to the central control device 31 to be used for calculations performed by the invention.

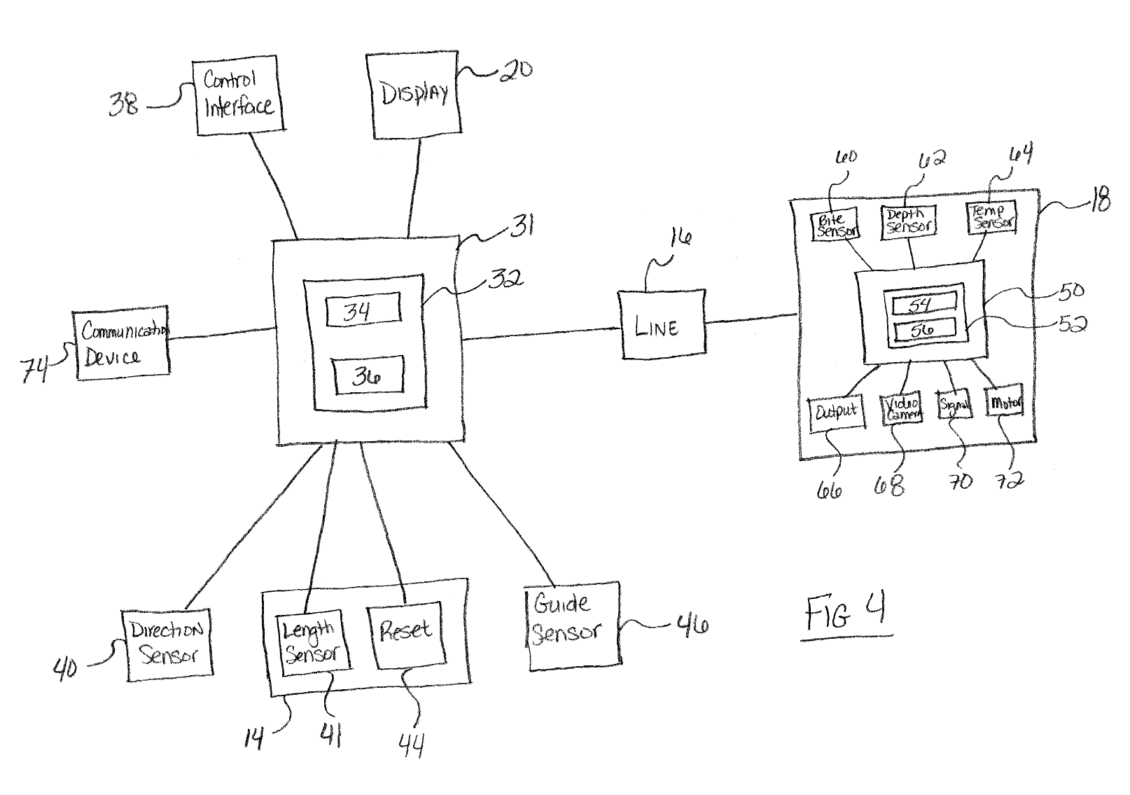

Referring now to FIG. 3, the lure 18 contains a data processing unit 50 that includes a circuit board 52, a computer chip 54 and a battery 56. The battery 56 is used to power the data processing unit 50 and is preferably rechargeable. The data processing unit 50 of the lure 18 allows the lure 18 to be used to perform and collect real time fishing measurements and functions. Preferably, the computer chip 54 is Texas Instruments Model MSC1212Y5, but one skilled in the art will appreciate that any number of chips may be used. The lure 18 has at least one hook 58 for engaging a fish. The hook 58 contains a bite sensor 60 for detecting bites and nibbles by fish. The bite sensor 60 is preferably a strain gauge sensor, but numerous other types of sensors may be used to achieve the same result. The information from the bite sensor 60 is transmitted to the data processing unit 50 in the lure which then transmits the data to the central control device 31 in the handle portion 22 of the rod 12 via the line 16. The central control device 31 can then convert the measured values into force pound values and output that information to the display 20. The invention can use this information from the bite sensor 60 to allow the fisher to control the action or allow the invention to automatically control the various options and functions of the lure 18 as described hereinbelow in order to further entice the fish or to repel the fish. Preferably, the hook 38 is detachable from the lure 18 in the event of a snag thereby allowing the lure 18 to be retrieved by the fisher. If the lure 18 has multiple hooks 38, the lure is preferably able to sense and determine which hook 38 is snagged and selectively release only that particular hook 38.

The lure 18 also has at least one depth sensor 62 for measuring depth and operating as a fish finder for determining the location and count of fish in the surrounding area. The lure 18 may also contain a temperature sensor 64 to determine the temperature of the water surrounding the lure 18. According to the preferred embodiment of the present invention, the lure 18 further includes an output device 66 that is configured to emit sounds, light, scent, and/or blood to attract certain types of fish. These features of sounds, scents, etc. are selectable either manually by the fisher or automatically by the invention such that certain sounds and/or scents may be emitted depending on the type of fish either near the lure or that the fisher hopes to attract. Optionally, the lure 18 may be configured to fire an explosive to disable a fish or emit an electric shock to immobilize a fish in an effort to prevent the fish from continuing to fight on the fisher's line. The lure 18 can also be equipped with a video camera 68 for displaying video images to the fisher via the display 20. The lure 18 may also be equipped with a signaling beacon 70 that allows a fisher to find a lure that has become lost either in the water or elsewhere. Additionally, the lure 18 may be further equipped with a motor 72 thereby providing movement to the lure 18 in order to imitate movement of certain types of prey. Yet another optional feature of the lure 18 is a collapsible hook (not shown) that could collapse upon command by the fisher. A collapsible hook would be a benefit when the fisher does not want a particular fish located near the hook or even in the case of a snag. Once a fish is caught, the bite sensor 60 or a separate sensor can determine the weight of the fish and allow the fisher to selectively release certain sized fish. Another optional feature of the lure 18 is the inclusion of a compartment (not shown) to take on water or release water in order to adjust the lure depth in the water. The lure 18 features described above may be used at the fisher's command or may be controlled automatically by the invention.

The present invention utilizes a computer program, or software, which is preferably part of the central control device 31 to collect and interpret the data sent by all of the sensors of the present invention in order to control the invention. The software controls multiple features including, but not limited to, alerts, lure options, output to peripheral devices, and memory storage. Whether lure 18 control is performed automatically or manually by the fisher, the software relays commands to the lure 18 and any of its various components. The software may also control an automatic electric reel 14, which is optional. During the fisher's action for reeling in a fish, especially a large heavy fish, the software can automatically reel in the fish according to data collected from the sensors especially as related to the action of the fish. Typically, the fish will fight and run out the line 16, and then the fisher must repeatedly pull the fishing rod/pole 12 upward and inward to reel in the line 16 until the fish is brought to the fisher's location. This repeated action can take up to two to three hours in extreme cases and can be exhausting. The use of an automatic reel controlled by the invention would emulate this process and make the catch easier on the fisher.

The software may also be configured so as to enable the invention to transmit real time fishing data to another source via a communication device 74. The communication device 74 can be configured to communicate with another source via various transmission means such as the Internet and television, in order to allow the real time data to be viewed by third parties. One skilled in the art will appreciate that the software can be configured in numerous different ways to use the data collected and transmitted by the present invention.

In an alternate embodiment of the present invention, the rod 12 does not house the central control device 31 in the handle portion 22. Instead, a computing means such as the central control device 31 is provided in a separate unit preferably a display unit 20. In this embodiment, the data is passed to the display unit 20 for processing. The display unit 20 could be mounted on the rod 12 or reel 14 as described above or could be separate from the rod 12. In accordance with this alternate embodiment, if the display unit 20 is a fish finder which are often used on boats, the fish finder can communicate with the motor 72 in the lure 18 in order to automatically move or reposition the lure 18 into an area where fish have been found.

In another alternate embodiment of the present invention, the lure 18 could be adapted to send data to the central control device 31 or any similar computing device, whether located in or on the rod 12 or in a separate display unit 20, wirelessly. In this embodiment, the line 16 may be standard fishing line instead of the fiber optic cable preferred in other embodiments.

Many variations and modifications may be made to the preferred embodiment as described herein without straying from the scope of the present invention. For example, the battery 36 of the central control device 31 in the handle portion 22 of the rod 12 and the battery 56 of the data processing unit in the lure 18 may be recharged via a power cord connector or may be solar charged or they may be replaceable standard sized batteries. Further, additional sensors may be placed on the rod 12 to sense the bowing of the rod 12 in order to measure the overall stress and force exerted on the rod 12 at all times. Another example of a modification that is within the scope of the present invention is not including the display 20 on the rod 12 and/or enabling the rod 12 to transmit information to be displayed to another device such as a depth finder installed on a boat or a computer either via a wired connection or via wireless communication. In yet another example of further functionality, the invention could be set into trolling mode to allow the fisher to troll without affecting the real time fishing data. In another example, the invention may be configured to allow the fisher to store fishing data and/or video on either an internal hard drive, a removable memory card, and/or an external hard drive. In the case of an internal hard drive, the fisher could export such data for use with another device either by direct connection or wirelessly. The above mentioned examples are for example only and are not included so as to limit the scope of the present invention.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A computerized fishing rod and lure system for collecting and analyzing fishing data to provide for manual or automatically controlled fishing experience comprising:
a fishing rod having a handle portion and a shaft portion;
a fishing line reel;
a fishing line encased in said fishing line reel;
a plurality of guides located along said fishing rod for guiding said fishing line along said fishing rod;
a lure attached to said fishing line;
a central control device electrically coupled with said fishing rod for receiving, manipulating and outputting data, said central control device further configured to control said lure;
a display device electrically coupled with said central data device and capable of receiving and displaying data from said central control device; and
a sensor located on at least one of said fishing rod and said lure and electrically coupled with said central control device for sensing and sending data to said central control device, wherein said central control device uses the data received from said sensor to display data to the user via said display device and control the operation of said fishing rod and lure system.

2. The system of claim 1 wherein said display device is mounted on said handle portion of said fishing rod.

3. The system of claim 1 wherein said plurality of guides is located along said shaft portion of said fishing rod.

4. The system of claim 1 wherein said fishing line reel is mounted on said handle portion of said fishing rod.

5. The system of claim 1 wherein said central control device is encased in said handle portion of said fishing rod.

6. The system of claim 1 further including a control interface for allowing a user to interact with said central control device.

7. The system of claim 1 wherein said sensor is coupled on one of said plurality of guides to sense the stress and force of the rod and send the corresponding data to said central control device.

8. The system of claim 1 wherein said sensor is coupled with said fishing line reel for sensing the length of the fishing line and sending the corresponding data to said central control device.

9. The system of claim 1 further comprising a reset button electrically coupled with said central control device for resetting the data prior to a new cast of said lure.

10. The system of claim 1 wherein said lure further includes at least one hook.

11. The system of claim 10 wherein said at least one hook includes a selective release mechanism for selective release of said hook from said lure.

12. The system of claim 10 wherein said at least one hook includes a collapsing mechanism for collapsing said hook.

13. The system of claim 10 wherein said lure further includes a data processing unit electrically coupled with said central control device for transmitting data and controlling said lure.

14. The system of claim 13 wherein said fishing line is capable of transmitting data between said data processing unit and said central control device thereby allowing said central control device to receive data from said data processing unit in said lure and send commands to said lure via said central control device.

15. The system of claim 13 wherein said data processing unit and said central control device transmit data wirelessly.

16. The system of claim 13 wherein said lure further includes at least one of a bite sensor coupled with said hook for detecting fish activity, a depth sensor for measuring the depth of said lure, and temperature sensor for measuring the temperature of the water around said lure wherein each of said bite sensor, depth sensor and temperature sensor is electrically coupled with said data processing unit for transmitting the sensed data to said data processing unit.

17. The system of claim 1 wherein said lure further includes a video camera, wherein the video stream is transmitted to said central control device and said central control device transmits the video stream.

18. The system of claim 1 wherein said lure further includes an output device capable of outputting at least one of sound, scent, light, and blood to attract fish.

19. The system of claim 1 wherein said lure further includes a signaling device for enabling a user to locate a lost lure.

20. The system of claim 1 wherein said lure further includes a motor for enabling movement of said lure in water.
